(19) United States
(12) Patent Application Publication
(10) Pub. No.: US 2015/0009010 A1
(43) Pub. Date: Jan. 8, 2015

(54) VEHICLE VISION SYSTEM WITH DRIVER DETECTION

(71) Applicant: MAGNA ELECTRONICS INC., Auburn Hills, MI (US)

(72) Inventor: Michael Biemer, Aschaffenburg-Obernau (DE)

(21) Appl. No.: 14/316,940

(22) Filed: Jun. 27, 2014

Related U.S. Application Data
(60) Provisional application No. 61/931,811, filed on Jan. 27, 2014.
(60) Provisional application No. 61/845,061, filed on Jul. 11, 2013.
(60) Provisional application No. 61/842,644, filed on Jul. 3, 2013.

(51) Int. Cl. G06F 21/32; G06K 9/00; G01G 19/44

(52) U.S. Cl. CPC G06F 21/32; G01G 19/44; G06K 9/00268
USPC 340/5.83

(57) ABSTRACT

A vision system of a vehicle includes an interior camera disposed in an interior cabin of a vehicle and having a field of view interior of the vehicle that encompasses an area typically occupied by a head of a driver of the vehicle. An image processor is operable to process image data captured by the camera. The image processor is operable to determine the presence of a person's head in the field of view of the camera and to compare features of the person's face to features of an authorized driver. Responsive at least in part to the comparison of features, operation of the vehicle is allowed only to an authorized driver. The system may store features of one or more authorized driver and may allow operation of the vehicle only when the person occupying the driver seat is recognized or identified as an authorized driver.

### CROSS REFERENCE TO RELATED APPLICATIONS

The present application is related to U.S. provisional applications, Ser. No. 61/931,811, filed Jan. 27, 2014; Ser. No. 61/845,061, filed Jul. 11, 2013, and Ser. No. 61/842,644, filed Jul. 3, 2013, which are hereby incorporated herein by reference in their entireties.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935; and/or 5,550,677, which are hereby incorporated herein by reference in their entireties.

### SUMMARY OF THE INVENTION

The present invention provides a collision avoidance system or vision system or imaging system for a vehicle that utilizes one or more cameras (preferably one or more CMOS cameras) to capture image data representative of images interior and/or exterior of the vehicle, and provides a driver's head detection and recognition system, which, upon detection and recognition of the driver's head and face, may communicate with a keyless start system of the vehicle to allow the driver to start the vehicle. Optionally, the system may detect and recognize the face of a person outside and approaching the vehicle and, upon detection and recognition of the person's face, may communicate with a keyless entry or passive entry system of the vehicle to unlock the vehicle door to allow the driver to open the vehicle door.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention; and

FIG. 2 is a perspective view of a vehicle having a camera at a side of the vehicle in accordance with the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

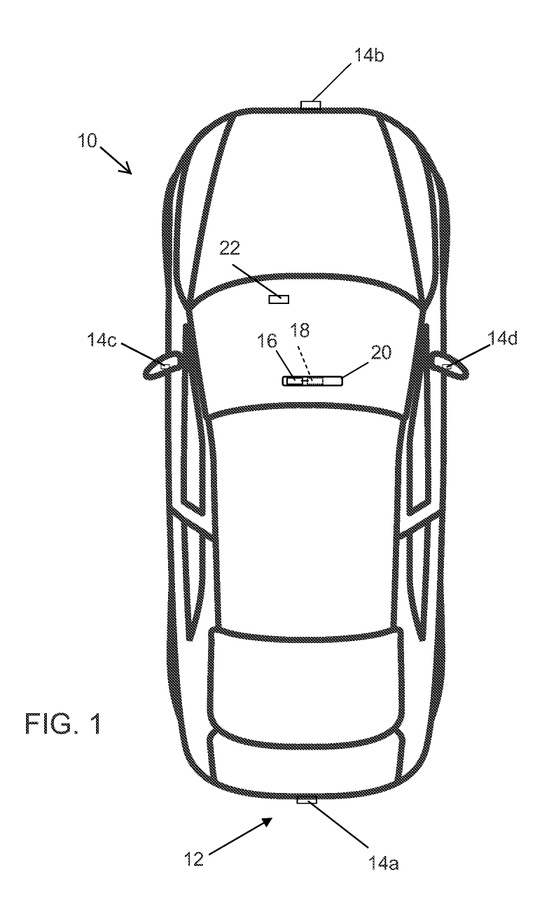

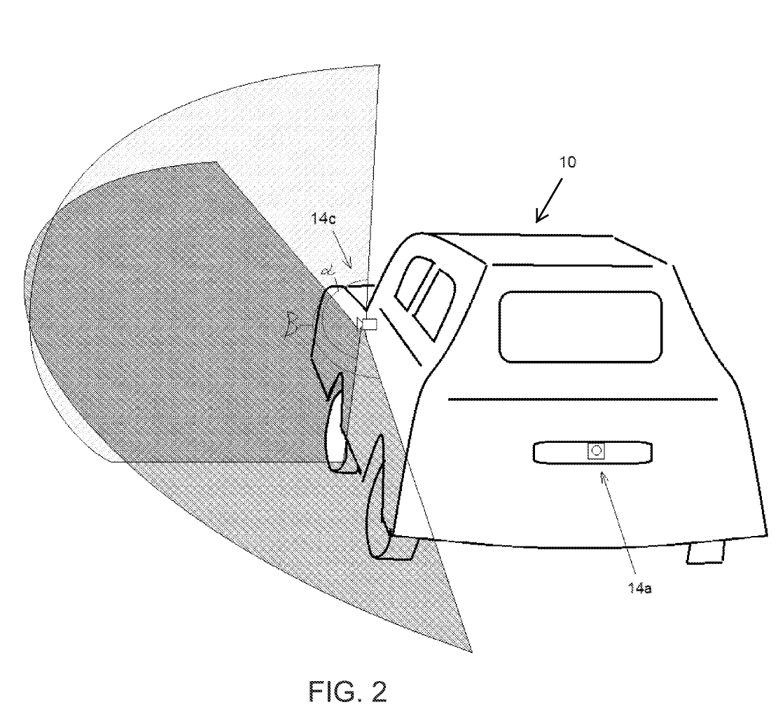

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The cameras may be arranged so as to point substantially or generally horizontally away from the vehicle. The lens system's vertically opening angles α may be, for example, around 180 degrees, and the horizontally opening angles β may be, for example, around 180 degrees, such as shown in FIG. 2. The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The vision system 12 includes an interior camera 22, which may be operable to capture images of the driver's head area so that the system may detect and recognize the head and face of the driver of the vehicle, as discussed below. The camera 22 may be disposed at or in the mirror head of the mirror assembly (and may be adjusted with adjustment of the mirror head) or may be disposed elsewhere within the interior cabin of the vehicle, with its field of view encompassing an area that is typically occupied by a driver of the vehicle when the driver of the vehicle is occupying the driver's seat of the vehicle and normally operating the vehicle.

There are already applications in vehicles using tracking systems that may detect the driver's head position and viewing direction and the driver's eye gaze direction, such as systems that may be useful in determining the driver's alertness or condition, such as drowsiness or the like. Such a system may utilize suitable processing techniques to determine the driver's eye gaze, such as by utilizing aspects of the systems described in U.S. provisional application Ser. No. 61/977,941, filed Apr. 10, 2014, which is hereby incorporated herein by reference in its entirety. Some of these types of systems may determine driver drowsiness or attentiveness by observing the time intervals the acceleration paddle position is changed by the driver's foot, while some systems may determine driver drowsiness or attentiveness by observing the time intervals between changes in the steering wheel position made by the driver, and some systems may determine driver drowsiness or attentiveness by monitoring the closing time and repetition rate of the driver's eye lids and eye movement. Typically, these systems use mono or stereo cameras or camera arrangements, especially infrared cameras often in combination with an infrared illumination source often comprised by infrared LED. Typically, the cameras and light sources are placed on or at or near the dash board to see the driver mostly from the front. Such systems may, for example, utilize aspects of the systems described in U.S. Pat. No. 7,914,187, which is hereby incorporated herein by reference in its entirety.

Head and face direction and position tracking systems and or eye tracking systems may find use (or additional use) in supporting or adding to other systems. The systems may also find use in supporting entry access and/or engagement admission systems, such as vehicle inherent keyless entry/go systems (such as passive entry systems and keyless start systems and/or the like).

These systems typically include a plurality of antennas for providing a low frequency (such as around 125 kHz or 130 kHz or thereabouts) and high frequency (such as around 433 MHz, 868 MHz or 315 MHz or thereabouts) data communication between the vehicle and the key fob for identifying the key and giving or denying the door access. Additionally, there are antennas in the vehicle to clearly detect whether the key fob is within the car or maybe in the trunk or maybe just laying outside on the windshield (which may often be the most difficult case to detect). Often, the keys or key fobs come with a redundant hardware as another safety layer for allowing or denying the starting of the vehicle. This hardware often comprises a radio frequency identification (RFID), having (maybe passive) RFID chips in the key and a receiver with a field emitter in the key area or glove compartment area of the vehicle or a kind of near field communication chip set or the like. The use and addition of the antennas in the vehicle are typically a substantial cost driver. For example, a 7er BMW has up to seven antennas which all need CAN access, wake up functionalities and so on.

The present invention provides a vision system that functions as a Keyless Entry/Go system that may be reduced in costs by limiting or obviating or eliminating the need for most of the antennas, such as the inside antennas (disposed at or in the vehicle). This may be achieved by identifying that an authorized driver is inside the vehicle (such as in the driver seat) and is allowed to drive the car via a vision system of the vehicle, such as a head or face (acknowledging and) tracking system or eye tracking system. Thus, upon detection of and recognition of an authorized driver in the driver seat (which is determined via comparison of features of the face of the person occupying the driver seat with features of an authorized driver), the system may communicate with the keyless start system to allow the person at the driver seat to start the vehicle.

The system may store one or more reference images or key markers of the driver's face and/or eyes. The key markers may, for example, include one or more of the following:
Eye distance or spacing;
Eye nose tip triangle shape or distances;
Iris color;
Eyeball color;
Eye texture;
Eye size;
Eye-forehead distance;
Nose-forehead distance;
Nose-mouth distance;
Chin-mouth distance;
Chin-nose distance;
Chin-Ear distance;
and/or any combination of one or more of the above features or biometric characteristics or markers.

The method or system of the present invention requires feature extracting and tracking. Methods for extracting and tracking features, such as the iris, are known. Advanced systems may be unknown in automotive which also comprise retina scan and compare functionality.

Optionally, the system or method of the present invention may not include edge discrimination and feature tracking and compare, but instead a classifying, segmentation or clustering method may come into use (for a face, eye or retina identification). This may be a supervised (such as like Adaboost), but preferably is an unsupervised clustering method, such as like a Markov model, a Bayesian classifier, K-Means, neural net or other statistically knowledge based adaption or learning system. Prior to that there may be a kind of DCT employed for image frequency device.

The system may possess a pre-learned data set of a plurality of (preferably adult) human faces, which serves to generalize a human face. Since an end of line system cannot have the specific driver's face as a pre-learned data set, an adaption/learning phase may be necessary (for learning the specific driver's specific face features apart from human faces general features). This may be done by using prior uploaded diver's face parameters (these may have been extracted from annotated data collections of the individual driver's face and body from online platforms such as, for example, Facebook, Google Picasa and the like) or this may initially be done when the driver enters his or her vehicle for the first time, and maybe during the hand over at the dealership's site. This learning may be resettable by entering a one-time master code, such as at the time that a vehicle is sold used to consecutive owner, with the master code provided by the OEM, tier supplier or a third party service, preferably in a very secure way, for vehicle ownership identification to prevent to overcome the drive access on broken into vehicles and stolen vehicles. Optionally, the system may learn a number of persons who have allowance or authorization to drive the vehicle, such as all of the licensed family members of the vehicle owner. The system may allow (via entering of the appropriate code or password) any number of drivers to be learned and recognized and may delete any of the learned drivers from memory (such as for removing the initial owner from memory when he or she sells the vehicle to a subsequent owner).

When learning the driver features or driver identifiers or identification, the system may discriminate the driver's head via known algorithms. The system may read and classify/cluster/segment several consecutive images adding to a class/segment of allowed drivers. The person or driver may have to turn his or her head and eventually may have to remove his or her glasses during the learning procedure. The learning steps or process or procedure may be described in the driver's manual or guided by a vehicle inherent human machine interface (HMI) system, such as audio or video outputs, interaction with an avatar (such as via a step by step interaction with the driver identification learning procedure) or the like (such as a video instruction or the like at a video display of the vehicle). As an alternative option the system may learn the driver's properties in silence after he or she enters the vehicle under use of the master code.

After the learning procedure is successfully passed, the system's function may be to detect a person when the person enters the driver seat area and sits at the driver seat, and may run a classification. If the result is that the driver's face matches or substantially matches one of the allowed drivers, the access may be given. Otherwise, the access may be denied. The system may always store the actual classified image via the learning algorithm for adapting the “allowed drivers” class/segment vector content to the minor changes of drivers faces over time, such as like haircuts, skin folds, blains, grains or the like.

Optionally, the driver identification system, in addition to comparing body markers of an individual driver when deciding to give access authorization or not, dynamic markers or parameters may be used. In U.S. patent application Ser. No. 14/272,834, filed May 8, 2014 (Attorney Docket MAG04 P-2278), which is hereby incorporated herein by reference in its entirety, a classification model is described for determining the driver's or user's needs and the preferably invoked functions, modes or vehicle systems by classifying conditions or contexts or driver habits, the rate of replication of driver interactions or inputs. Similar to this, the driver habits or typical actions or movements, such as typical gestures, way of looking (for example such as if the driver raises his or her eye brows in specific kinds of situations), how the driver puts his or her hands on the steering wheel, how the driver blinks (speed and closing time of the eye lids), the way the driver opens his or her eye lids, scratches his or her head, shakes his or her hair, licks his or her lips, how a double chin wobbles, how the driver chews and the like, may come into use as dynamic markers or parameters. Such markers occur over a (typically or repeatedly shown) period of time or sequence (and may be captured as a sequence of images or sequential frames of image data by the interior camera) and not just in a single frame of captured image data. The driver identification system may utilize a classification model in which the key features of a sequence are entered while the less relevant features of a sequence may diminish over consecutive times of (driver identification) learnings. Thus, the system may recognize willingly entered gestures (such as gestures for identifying the driver such as typing (in a master access code) with the hand in the air on a virtual keyboard or the like), and may utilize learning and identification of the unwilling style of acting or habitual actions or just looking to provide enhanced learning to the identification system of the present invention.

According to another aspect of the present invention, the system may be able to also detect and classify potential drivers' faces of people that are approaching the vehicle (still outside the vehicle). These individuals' faces may be captured by vehicle mounted cameras mounted outside of the vehicle (such as at an exterior rearview mirror assembly of the vehicle or the like) or by the cameras inside the vehicle detecting the person driver when looking through a window, especially the driver door's window. Upon detection and recognition of an authorized or allowed person approaching the vehicle, the system may communicate with a passive entry system of the vehicle, which may unlock and/or open the door for the approaching person, and/or upon detection and recognition of an authorized or allowed person sitting at the driver seat of the vehicle, the system may communicate with a keyless start system of the vehicle, which may allow the person to start the vehicle and drive the vehicle.

According to another aspect of the present invention, the system may be part of a higher sophisticated access system having some additional access hurdles hindering unauthorized individuals to enter and start the vehicle. For example, the system may be embedded as an additional safety stage to a HF- and LF-radio wave authorization (via encryption keying) based keyless entry/go system. The radio antennas on such a system may not be able to exactly localize the key fob. It may be sufficient that the radio antenna system is able to detect that the key fob is in an area in or around the vehicle within a threshold distance, such as, for example, within a radius of about six meters or thereabouts, since the “driver face authorization system” may make sure the driver has entered the driver seat when enabling the start access for the engine (drive access at e-cars).

According to another aspect of the present invention, the higher sophisticated access system may take other driver specific body markers into account for giving or denying access. For example, a seat occupation sensor may be able to store a specific driver's body weight. There might be a plausible range in which a driver's body weight may be able to change between two consecutive access times. By storing the last body weight, the system may be able to give or deny access based on a plausible range of his/her weight positively and negatively when entering the vehicle a consecutive time. For example, a 80 kg male driver may change by a maximal (about) +/−three kilogram within a two day time period, and based on this parameter, the system may give access to a driver with a face that substantially matches the authorized or stored face and with a weight of about 81 kg, and may deny access to a potential thief with a printed mask of the allowed driver's face (for overcoming the face access system) with a weight of, for example, about 88 kg (all that in presence of an authorized key fob as primarily security instance). The weight determination (and/or other biometric characteristic, such as height or position of the driver's face when sitting in the driver's seat) thus provides another security level to limit or reduce the possibility that the system may provide access or authorization to a person that is not an authorized vehicle user or owner.

According to another aspect of the present invention, more advanced classifying image processing access systems may be based on three dimensional (3D) images rather than two dimensional (2D) images. Both learned data as well as test case (access) data.

Optionally, and as another aspect of the present invention, the above keyless entry/go access admission system may find use in conjunction with a power lift gate triggering and object collision prevention system, such as described in U.S. patent application Ser. No. 14/159,772, filed Jan. 21, 2014 (Attorney Docket MAG04 P-2215), which is hereby incorporated herein by reference in its entirety.

According to another aspect of the present invention, the above keyless entry/go access admission system may find use in conjunction with a vehicle park surveillance system for preventing and video recording vandalism, hit and run and break-in, such as described in U.S. patent application Ser. No. 14/169,329, filed Jan. 31, 2014 (Attorney Docket MAG04 P-2218), which is hereby incorporated herein by reference in its entirety.

According to another aspect of the present invention, the face or eye detection and tracking system's cameras and/or illumination source, especially IR-LED or the like, may be placed in these positions:
Close or integrated to the projector of a head up display, preferably using the same or part of the lens and mirror system or using an alternative lens and mirror system;
Integrated to the dash board directed to the windshield in a position and angle to view or image the driver's face in the windshield glass reflection. Preferably, the window surface is at an (wide) angle so that the light rays coming from the direction of the cabin, especially from the driver's face, are reflected totally or nearly totally. When arranged at an angle that total reflection cannot be achieved, there may be a black coating on the outside of the windshield to hold off disturbing light. Alternatively, or additionally, there may be a mirror like reflective coating or an additional mirror on the concerned area of the windshield so that the light rays coming from the direction of the cabin, especially from the driver's face, are reflected to the camera which is sitting integrated to the dashboard, preferably in a kind of groove so as to not be seen in the direct line of view by the driver or other passengers, but may be slightly visible as a reflection off the windshield. It may be covered by a coating on the glass so as to not be seen from outside of the vehicle.
Integrated to an in-cabin central rearview mirror. By that it may comprise a common unit combined with other electrically and/or electronically systems placed at or in or near the mirror assembly, such as an integrated mirror display, a rear vehicle camera display, a rain sensor, the vehicle's forward viewing vision system's camera, an in cabin forward directed RADAR or a cabin illumination arrangement or the like, or maybe other accessories or systems or switches and controls and the like.
Integrated to the instrument panel or cluster, such as a cluster display, preferably behind the cluster and looking through it. The IR-LED may be part of the display back light illumination, and the display may be equipped with LEDs having substantially a visible wave length. According to an aspect of the present invention, such LEDs may have a wider spectrum, including IR or near IR or the like, or the backlight may have additional IR-LEDs. There may be an alternative shutting scheme of the TFT shutter. There may be a frame displaying a convenient visible image followed by a frame or interframe at which the shutter is open for the IR-Light. For example, a display may have a frame rate of about 60 Hz, running 30 Hz of visible image frames and 30 Hz of IR-illumination frames alternating to the visible frames. The IR-frames may have an image structure which may be usable as a structured light illumination source for room depth detection, for the head and eye distance detection and/or the like.
Integrated or on top of the steering column.
Integrated to the steering wheel.
Integrated to an A-pillar display arrangement.
Integrated or behind the compartment or windshield air duct.
Integrated to the radio column.

At all of the suggested positions above and otherwise, the cameras and/or illumination source may be hidden behind an (design-) element (such as like a covering lid or the like) which is mostly IR-light transmissive and mostly light in-transmissive or non-transmissive in visible wave lengths. It may have any (reflective) color in visible light, preferably the color is like its surrounding (visible) surface elements (in which it is embedded), so as to not disturb the interior design. The design element or lid may be a part of a housing of the system's device.

According to another aspect of the present invention, the system's eye tracking may be utilized for controlling, waking up or switching devices on and off or adjusting illumination, responsive to identification of the authorized driver or user and/or to identification of a movement or position or gesture or gaze or movement of the authorized driver or user. As a specific example, the application may be done in a way that the background or self-illumination of a device turns or fades on at a time the driver's view glides over it. The turning or fading on may have a delay time constant of, for example, about 0.25 seconds. The devices background illumination may stay on for a certain period of time. The time constant before turning or fading off may be in an area of, for example, around 1.5 seconds. As an example, the back light illumination of the HVAC may fade on fast when the driver is looking at it longer than 0.25 seconds, and when his or her view may then turn (e.g., ocular drifting) to, for example, the radio control, the radio control's back light may also fade on after about 0.25 seconds. When the driver then turns his or her view back to the traffic (such as forward and through the windshield of the vehicle), the HVAC control's back light illumination and a moment later the radio control's back light illumination may fade off or down. Another example of a driver's view control is described in U.S. provisional application Ser. No. 61/941,568, filed Feb. 19, 2014, which is hereby incorporated herein by reference in its entirety.

According to another aspect of the present invention, the system's eye tracking may be utilized for analyzing the driver's attention to the traffic scene and attention distractions. Such types of attention tracking have been proposed for scientific statistical analyses on driver attention and behavior. The present invention uses such produced information for improving the performance of ADA systems. As a specific example, a known art traffic sign recognition system may detect traffic signs that the vehicle is passing and may display it at a display in the vehicle, such as, for example, a head up display or the like. Often, there is a ranking in the priority of displayed traffic signs. For example, speed limits may be displayed preferably over a parking prohibition sign. Often the attention to the change, especially a further reduction of a speed limit, may be heightened by generating an audible alert or alarming sound as like a “bling” tone or the like. Other driver assistant systems in the vehicle, such as lane assistant systems or the like, may also support the driver with further overlays within his/her view and audio signals or haptic feedback. On lane assistant systems, the haptic feedback typically comes over the steering wheel. The lane assistant tends to turn the vehicle back to the dedicated lane (the lane that the system, not necessarily the driver, thinks is the right lane for travel). For that a small force becomes applied by the system. Additionally, the driver may pay attention to non-traffic related devices or applications. All these signals may lead to an overload of the driver in some busy situations. The driver may not be able to grasp and discern and understand all of the offered help and information and all of the audio signals for securely controlling his or her car at all times.

For avoiding the overwhelming of the driver with aiding/assisting/educating/entertaining signals, later on referred to as aiding (video, audio, haptic) from ADA systems, there may be a system employed which utilizes an eye tracker which has a comparably high accuracy (such as less than about 0.5 degrees of steradiant). Such a system may be able to detect whether or not a driver has picked up a particular event or sign within the traffic real or partially augmented traffic scene (a partial augmentation of the driver's view is shown in U.S. patent application Ser. No. 14/272,834, filed May 8, 2014 (Attorney Docket MAG04 P-2278), which is hereby incorporated herein by reference in its entirety) by monitoring the driver's viewing direction and how long it rests (fixates) on a certain object or area in the view. By fixating (resting) on an object or area, the view may not be fully static, since due to the ego motion of the vehicle, the view area is moving (vestibulo-ocular reflex as well as optokinetic nystagmus). Additionally, the eye typically does small movement steps quasi scanning an object, called drifts and saccades, both done unconsciously. There may be a duration (maybe greater than about 0.3 seconds) until the system may assume the driver has consciously noticed an event, sign or hint. At those times (events), the system may not additionally provide its aiding function or may less obtrusively provide its aiding function or may provide its aiding function in a less critical/accurate/prudent/wearied/anxious manner. As a specific example, the system may not, or may less obtrusively, display a newly changed (or any other earlier) speed limit in the head up display (or any other displaying device) at times the driver has certainly noticed a speed limit sign by himself or herself by fixating it long enough (such as, for example, looking at it for at least a threshold period of time, such as greater than about 0.3 seconds or thereabouts) to detect the driver's fixated view by the eye tracker.

As another example, the lane assist may not “try” to intervene at times when the system detects that the driver is fixating the lane markings consciously (long enough) and repeatedly so it assumes it is his clear, conscious will to violate (cross over) a lane marking, may it be to do a lane change (without blinking) or cutting a curve and crossing the inner lane marking by that. The system may aid less prudently, by intervening not already when the wheel is partially on the lane marking but maybe when the car is already one third over the inner curve marking.

The duration until the system decides (assumes) the driver has fixated an area, event, sign, or hint long enough (later referred as “fixation time”) may be driver specific, drowsiness specific, stress specific (driving paired with distractions) and/or context specific.

Additional to the attention the driver pays to the traffic (measuring the eye fixation on an area, event, sign, or hint) also the ratio of signaling or intervention measure (later referred as “signaling/intervention ratio measure”) in between very prudent and less prudent levels may be controlled driver specifically, driver drowsiness specifically, stress specifically (driving paired with distractions) and/or context specifically.
The drowsiness may be measured/rated by known methods and algorithms. Usual methods monitor the eye lid closing time as a measure (beside others).
The stress may be measured by the number and time duration in between events that occur to the driver and as an additional measure the duration between driver inputs.
Context related conditions may include:
   in city or high traffic driving
   motorway driving
   intersection entering/driving
   on ramp driving/entering/exiting
   tunnel driving/entering/exiting
   parking house driving/entering/exiting
   car wash through driving
   overtaking (a general road participant)
   being overtaken by general road participant
   being overtaken by emergency vehicle/police/fire truck
   cruise controlled driving
   lane assisted driving
   traffic jam driving/approaching
   snow condition driving
   icy condition driving
   dusty/foggy condition driving
   rain condition driving
   night condition driving
   off road condition driving
   approaching an accident scene (not involved in)
   involved in an accident condition
   emergency condition (such as being robbed, hijacked, on the run, on the way to the hospital)
   beginner driver conditions
   high/drunk driving conditions
   elderly driving conditions
   other less definable driving conditions such as female or male driving styles

The function, relation or dependency of “fixation time” and “signaling/intervention ratio measure” may be set in a look up table which may be under consideration of scientific knowledge concerning human perception physiology.

According to another aspect of the present invention, there may be an adaption or learning algorithm involved additionally or alternatively. The adaption or learning algorithm may use the above mentioned look up table parameter set as starting parameters. This adaption or learning algorithm may be a supervised as like Adaboost, preferably an unsupervised classifying, segmentation or clustering method as like a Markov model, a Bayesian classifier, K-Means, neural net or combinations of it or otherwise statistically knowledge based.

By the above learning/adapting, the system may be able to assimilate the driver's driving style, preference and likes. There may be a separate classification model or data set according each driver (preferably) or combined (not preferred). There may be a separate classification model or data set according each supported context or combined. It may turn out that some context can be handled as one or left out entirely (such as for simplifying/optimizing performance or since contexts are too irrelevant or too similar).

Optionally, the driver identification classification model (for access control) may be combined or identical to the learning/adapting model or system for assimilating the driver's driving style, preference and likes (such as for controlling prudent and less prudent levels of driving aid). Additionally, there may be a separate classification model or data set according each supported signaling/intervention ratio measure or combined. It may turn out that some signaling/intervention ratio measures can be handled as one or left out (such as for simplifying/optimizing performance or since contexts are too irrelevant or too similar). Alternatively, and preferably, the signaling/intervention ratio measure may be input parameters to each context adaption or learning model.

As a specific example, a lane assist system of the present invention may be implemented that may (try to) postulate whether and when to intervene with the driver's steering based on historically processed and learned/adapted driver behavior so it is the least disturbing and distracting and by that the best fitting, convenient and secure approach for that particular driver. In this example, the scene may stay in one context, such as, for example, the context of “motorway driving”. For example, the model may receive the input parameter value 2 (of five: 2/5) on a measure of drowsiness having, for example, five levels or increments on the scale between asleep 5 to wide awake 0 (which may be concluded by the driver's gaze and eye lid activity), for having a quite awake driver. The stress parameter may have a value of 4 (4/15) on a scale of 0 to 15, with 0 meaning no events, no stress within the last ten seconds (arbitrary chosen value of ten seconds as an exemplary (rolling) time span between present and to the past) and 15 events meaning high stress, may also be an input. By that the stress level may be quite moderate in this example situation.

The learning model, which actually may be learned/adapted may have the number one out of three, since there may be three data sets for three (or more) possible (allowed) drivers. Due to these parameters, the model may adapt to intervene quite “late” or less prudent, by that allowing the vehicle to cross over lanes quite widely before intervening in cases where the driver has ‘looked at’ or fixated the respective lane markings involved. In cases where the (same) driver “one” is quite drowsy (such as having a drowsiness level expressed by a value of four out of five) and may have comparable high stress (such as having a stress level expressed by a value of 11 out of 15) and is still on the context “motorway driving”, the system may (assume to) intervene more prudent and by that intervening by sounding a beep (for waking up) and steering wheel actuation in direction of the driving lane's center already when the driver is close to a lane marking although his or her eyes were fixating the concerning lane markings.

The system may be able to learn or adapt itself to better perform by comparing the postulation and the later result as true or false. The result may be assessed as true when the driver doesn't act against the steering intervention (at a time of intervention) but continues to center the vehicle to a driving lane. The result may be assessed as false in cases where the driver acts against the intervention and overcomes the steering intervention force (at a time of intervention) for continuing to leave or stay off a lane marking and maybe fully leaving his or her previously used lane.

Assuming the example above identically except the context: assume that the driver would be approaching an exit ramp (context: “on ramp driving/entering/exiting”) from a motor way or freeway. Within this situational constellation, the system may not or may less obtrusively warn or intervene when the driver crosses an intermittent lane marking also when the driver pays low attention to that intermittent lane marking and maybe the navigation system advises to exit at that time (with a navigation system instruction or route optionally also being an input to the model or system).

By picking up the earlier example of having a model of a traffic sign assist implemented, the result may be assessed as true or false by assessing the driver's (consecutive) behavior. In cases where the system “assumes” that the driver has seen, for example, a speed limit sign by fixating it long enough and being attentive enough, the system may not display or may display the speed limit comparably less obtrusively. In cases where the driver then stays over the speed limit or accelerates the vehicle, the system may be able to improve its (postulation) performance. The driver (in that case) either doesn't want to stay below the speed limit range or he or she didn't conceived it. Since the driver was rated as attentive, the system may assume the driver is consciously violating the speed limit and the postulation was true. If the same case occurs with having a driver rated as comparably drowsy, the system may have to assess its postulation as false. The omission of warning the driver may be false in such a situation (drowsy driver), because the driver obviously did not see or comprehend the speed limit although the driver fixated on the speed limit sign, instead the system learns and adapts to warn the driver in these constellations of situation (driver, context, drowsiness, stress level). The system may also learn to adapt its assessment of the driver behaving drowsily.

According to another aspect of the present invention, there may be a feedback loop in the learning/adaption models for also varying the fixation time as a model parameter for deciding a fixation was long enough or not for conceiving the content information.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 2012/158167; WO 2012/075250; WO 2012/0116043; WO 2012/0145501; WO 2012/154919; WO 2013/019707; WO 2013/016409; WO 2013/019795; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661 and/or WO 2013/158592, and/or U.S. patent application Ser. No. 14/290,028, filed May 29, 2014 (Attorney Docket MAG04 P-2294); Ser. No. 14/290,026, filed May 29, 2014 (Attorney Docket MAG04 P-2293); Ser. No. 14/359,341, filed May 20, 2014 (Attorney Docket MAG04 P-1961); Ser. No. 14/359,340, filed May 20, 2014 (Attorney Docket MAG04 P-1961); Ser. No. 14/282,029, filed May 20, 02014 (Attorney Docket MAG04 P-2287); Ser. No. 14/282,028, filed May 20, 2014 (Attorney Docket MAG04 P-2286); Ser. No. 14/358,232, filed May 15, 2014 (Attorney Docket MAG04 P-1959); Ser. No. 14/272,834, filed May 8, 2014 (Attorney Docket MAG04 P-2278); Ser. No. 14/356,330, filed May 5, 2014 (Attorney Docket MAG04 P-1954); Ser. No. 14/269,788, filed May 5, 2014 (Attorney Docket MAG04 P-2276); Ser. No. 14/268,169, filed May 2, 2014 (Attorney Docket MAG04 P-2273); Ser. No. 14/264,443, filed Apr. 29, 2014 (Attorney Docket MAG04 P-2270); Ser. No. 14/354,675, filed Apr. 28, 2014 (Attorney Docket MAG04 P-1953); Ser. No. 14/248,602, filed Apr. 9, 2014 (Attorney Docket MAG04 P-2257); Ser. No. 14/242,038, filed Apr. 1, 2014 (Attorney Docket MAG04 P-2255); Ser. No. 14/229,061, filed Mar. 28, 2014 (Attorney Docket MAG04 P-2246); Ser. No. 14/343,937, filed Mar. 10, 2014 (Attorney Docket MAG04 P-1942); Ser. No. 14/343,936, filed Mar. 10, 2014 (Attorney Docket MAG04 P-1937); Ser. No. 14/195,135, filed Mar. 3, 2014 (Attorney Docket MAG04 P-2237); Ser. No. 14/195,136, filed Mar. 3, 2014 (Attorney Docket MAG04 P-2238); Ser. No. 14/191,512, filed Feb. 27, 2014 (Attorney Docket No. MAG04 P-2228); Ser. No. 14/183,613, filed Feb. 19, 2014 (Attorney Docket No. MAG04 P-2225); Ser. No. 14/169,329, filed Jan. 31, 2014 (Attorney Docket MAG04 P-2218); Ser. No. 14/169,328, filed Jan. 31, 2014 (Attorney Docket MAG04 P-2217); Ser. No. 14/163,325, filed Jan. 24, 2014 (Attorney Docket No. MAG04 P-2216); Ser. No. 14/159,772, filed Jan. 21, 2014 (Attorney Docket MAG04 P-2215); Ser. No. 14/107,624, filed Dec. 16, 2013 (Attorney Docket MAG04 P-2206); Ser. No. 14/102,981, filed Dec. 11, 2013 (Attorney Docket MAG04 P-2196); Ser. No. 14/102,980, filed Dec. 11, 2013 (Attorney Docket MAG04 P-2195); Ser. No. 14/098,817, filed Dec. 6, 2013 (Attorney Docket MAG04 P-2193); Ser. No. 14/097,581, filed Dec. 5, 2013 (Attorney Docket MAG04 P-2192); Ser. No. 14/093,981, filed Dec. 2, 2013 (Attorney Docket MAG04 P-2197); Ser. No. 14/093,980, filed Dec. 2, 2013 (Attorney Docket MAG04 P-2191); Ser. No. 14/082,573, filed Nov. 18, 2013 (Attorney Docket MAG04 P-2183); Ser. No. 14/082,574, filed Nov. 18, 2013 (Attorney Docket MAG04 P-2184); Ser. No. 14/082,575, filed Nov. 18, 2013 (Attorney Docket MAG04 P-2185); Ser. No. 14/082,577, filed Nov. 18, 2013 (Attorney Docket MAG04 P-2203); Ser. No. 14/071,086, filed Nov. 4, 2013 (Attorney Docket MAG04 P-2208); Ser. No. 14/076,524, filed Nov. 11, 2013 (Attorney Docket MAG04 P-2209); Ser. No. 14/052,945, filed Oct. 14, 2013 (Attorney Docket MAG04 P-2165); Ser. No. 14/046,174, filed Oct. 4, 2013 (Attorney Docket MAG04 P-2158); Ser. No. 14/016,790, filed Oct. 3, 2013 (Attorney Docket MAG04 P-2139); Ser. No. 14/036,723, filed Sep. 25, 2013 (Attorney Docket MAG04 P-2148); Ser. No. 14/016,790, filed Sep. 3, 2013 (Attorney Docket MAG04 P-2139); Ser. No. 14/001,272, filed Aug. 23, 2013 (Attorney Docket MAG04 P-1824); Ser. No. 13/970,868, filed Aug. 20, 2013 (Attorney Docket MAG04 P-2131); Ser. No. 13/964,134, filed Aug. 12, 2013 (Attorney Docket MAG04 P-2123); Ser. No. 13/942,758, filed Jul. 16, 2013 (Attorney Docket MAG04 P-2127); Ser. No. 13/942,753, filed Jul. 16, 2013 (Attorney Docket MAG04 P-2112); Ser. No. 13/927,680, filed Jun. 26, 2013 (Attorney Docket MAG04 P-2091); Ser. No. 13/916,051, filed Jun. 12, 2013 (Attorney Docket MAG04 P-2081); Ser. No. 13/894,870, filed May 15, 2013 (Attorney Docket MAG04 P-2062); Ser. No. 13/887,724, filed May 6, 2013 (Attorney Docket MAG04 P-2072); Ser. No. 13/852,190, filed Mar. 28, 2013 (Attorney Docket MAG04 P-2046); Ser. No. 13/851,378, filed Mar. 27, 2013 (Attorney Docket MAG04 P-2036); Ser. No. 13/848,796, filed Mar. 22, 2012 (Attorney Docket MAG04 P-2034); Ser. No. 13/847,815, filed Mar. 20, 2013 (Attorney Docket MAG04 P-2030); Ser. No. 13/800,697, filed Mar. 13, 2013 (Attorney Docket MAG04 P-2060); Ser. No. 13/785,099, filed Mar. 5, 2013 (Attorney Docket MAG04 P-2017); Ser. No. 13/779,881, filed Feb. 28, 2013 (Attorney Docket MAG04 P-2028); Ser. No. 13/774,317, filed Feb. 22, 2013 (Attorney Docket MAG04 P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), and/or U.S. provisional applications, Ser. No. 62/006,391, filed Jun. 2, 2014; Ser. No. 62/003,734, filed May 28, 2014; Ser. No. 62/001,796, filed May 22, 2014; Ser. No. 62/001,796, filed May 22, 2014; Ser. No. 61/993,736, filed May 15, 2014; Ser. 61/991,810, filed May 12, 2014; Ser. No. 61/991,809, filed May 12, 2014; Ser. No. 61/990,927, filed May 9, 2014; Ser. No. 61/989,652, filed May 7, 2014; Ser. No. 61/981,938, filed Apr. 21, 2014; Ser. No. 61/981,937, filed Apr. 21, 2014; Ser. No. 61/977,941, filed Apr. 10, 2014; Ser. No. 61/977,940. filed Apr. 10, 2014; Ser. No. 61/977,929, filed Apr. 10, 2014; Ser. No. 61/977,928, filed Apr. 10, 2014; Ser. No. 61/973,922, filed Apr. 2, 2014; Ser. No. 61/972,708, filed Mar. 31, 2014; Ser. No. 61/972,707, filed Mar. 31, 2014; Ser. No. 61/969,474, filed Mar. 24, 2014; Ser. No. 61/955,831, filed Mar. 20, 2014; Ser. No. 61/953,970, filed Mar. 17, 2014; Ser. No. 61/952,335, filed Mar. 13, 2014; Ser. No. 61/952,334, filed Mar. 13, 2014; Ser. No. 61/950,261, filed Mar. 10, 2014; Ser. No. 61/950,261, filed Mar. 10, 2014; Ser. No. 61/947,638, filed Mar. 4, 2014; Ser. No. 61/947,053, filed Mar. 3, 2014; Ser. No. 61/941,568, filed Feb. 19, 2014; Ser. No. 61/935,485, filed Feb. 4, 2014; Ser. No. 61/935,057, filed Feb. 3, 2014; Ser. No. 61/935,056, filed Feb. 3, 2014; Ser. No. 61/935,055, filed Feb. 3, 2014; Ser. No. 61/919,129, filed Dec. 20, 2013; Ser. No. 61/919,130, filed Dec. 20, 2013; Ser. No. 61/919,131, filed Dec. 20, 2013; Ser. No. 61/919,147, filed Dec. 20, 2013; Ser. No. 61/919,138, filed Dec. 20, 2013, Ser. No. 61/919,133, filed Dec. 20, 2013; Ser. No. 61/918,290, filed Dec. 19, 2013; Ser. No. 61/915,218, filed Dec. 12, 2013; Ser. No. 61/912,146, filed Dec. 5, 2013; Ser. No. 61/911, 666, filed Dec. 4, 2013; Ser. No. 61/911,665, filed Dec. 4, 2013; Ser. No. 61/905,461, filed Nov. 18, 2013; Ser. No. 61/905,462, filed Nov. 18, 2013; Ser. No. 61/901,127, filed Nov. 7, 2013; Ser. No. 61/895,610, filed Oct. 25, 2013; Ser. No. 61/895,609, filed Oct. 25, 2013; Ser. No. 61/879,837, filed Sep. 19, 2013; Ser. No. 61/879,835, filed Sep. 19, 2013; Ser. No. 61/875,351, filed Sep. 9, 2013; Ser. No. 61/869,195, filed. Aug. 23, 2013; Ser. No. 61/864,835, filed Aug. 12, 2013; Ser. No. 61/864,836, filed Aug. 12, 2013; Ser. No. 61/864,837, filed Aug. 12, 2013; Ser. No. 61/864,838, filed Aug. 12, 2013; Ser. No. 61/856,843, filed Jul. 22, 2013, Ser. No. 61/844,630, filed Jul. 10, 2013; Ser. No. 61/844,173, filed Jul. 9, 2013; Ser. No. 61/844,171, filed Jul. 9, 2013; Ser. No. 61/840,542, filed Jun. 28, 2013; Ser. No. 61/838,619, filed Jun. 24, 2013; Ser. No. 61/838,621, filed Jun. 24, 2013; Ser. No. 61/837,955, filed Jun. 21, 2013; Ser. No. 61/836,900, filed Jun. 19, 2013; Ser. No. 61/836,380, filed Jun. 18, 2013; and/or Ser. No. 61/833,080, filed Jun. 10, 2013; which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454; and/or 6,824,281, and/or International Publication Nos. WO 2010/099416; WO 2011/028686; and/or WO 2013/016409, and/or U.S. Pat. Publication No. US 2010-0020170, and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. patent application Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580; and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. Publication No. US-2006-0061008 and/or U.S. patent application Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249; and/or WO 2013/109869, and/or U.S. patent application Ser. No. 13/333,337, filed Dec. 21, 2011 (Attorney Docket DON01 P-1797), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. Publication Nos. US-2006-0061008 and/or US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. Publication No. US-2006-0050018, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
an interior camera disposed in an interior cabin of a vehicle and having a field of view interior of the vehicle that encompasses an area typically occupied by a head of a driver of the vehicle;
an image processor operable to process image data captured by said interior camera;
wherein said image processor is operable to determine the presence of a person's head in the field of view of said interior camera and to compare features of the person's face to features of an authorized driver; and
wherein, responsive at least in part to the comparison of features, operation of the vehicle is allowed only to an authorized driver.

2. The vision system of claim 1, comprising an exterior camera having a field of view exterior of the vehicle, wherein said image processor is operable to determine the presence of a person in the field of view of said exterior camera and to compare features of the person in the field of view of said exterior camera to features of an authorized driver, wherein, responsive at least in part to the comparison of features of the person in the field of view of said exterior camera, opening of a door of the vehicle is allowed only to an authorized driver.

3. The vision system of claim 1, wherein, responsive to a comparison of a weight of an authorized driver to a weight of the person when the person is occupying the driver seat of the vehicle as determined by a seat sensor at the driver seat, operation of the vehicle is allowed only to an authorized driver.

4. The vision system of claim 1, wherein, responsive to a comparison of a location of the person's head when the person is occupying the driver seat of the vehicle to a location of the head of an authorized driver, operation of the vehicle is allowed only to an authorized driver.

5. The vision system of claim 1, wherein said vision system is operable to learn features of an authorized driver.

6. The vision system of claim 1, wherein said vision system is operable to store features of multiple authorized drivers and, responsive to comparison of a person's face to features of the authorized drivers, operation of the vehicle is allowed only to one of the authorized drivers.

7. The vision system of claim 1, wherein said vision system is operable to determine a gaze direction of the authorized driver while the authorized driver is operating the vehicle.

8. The vision system of claim 7, wherein said vision system is operable to adjust at least one accessory responsive to the gaze direction of the authorized driver.

9. The vision system of claim 1, wherein said vision system learns a driving characteristic of the authorized driver and adjusts at least one accessory of the vehicle responsive to the learned driving characteristic.

10. The vision system of claim 9, wherein said vision system comprises a display screen operable to display traffic sign information indicative of a traffic sign ahead of the vehicle to enhance the authorized driver's awareness of the traffic sign.

11. The vision system of claim 10, wherein said vision system is operable to determine a gaze direction of the authorized driver while the authorized driver is operating the vehicle and is operable to determine when the authorized driver views the traffic sign, and wherein said vision system adjusts the display of the traffic sign responsive to the driver's gaze direction being towards the traffic sign.

12. The vision system of claim 11, wherein said vision system learns an attentiveness of the authorized driver when the authorized driver is operating the vehicle and wherein said vision system adjusts the display of the traffic sign responsive to the authorized driver's attentiveness and the driver's gaze being towards the traffic sign.

13. A vision system of a vehicle, said vision system comprising:
an interior camera disposed in an interior cabin of a vehicle and having a field of view interior of the vehicle that encompasses an area typically occupied by a head of a driver of the vehicle;
wherein said vision system is operable to store features of multiple authorized drivers;
an image processor operable to process image data captured by said interior camera;
wherein said image processor is operable to determine the presence of a person's head in the field of view of said interior camera and to compare features of the person's face to features of the authorized drivers;
wherein, responsive at least in part to the comparison of features, operation of the vehicle is allowed only to one of the authorized drivers; and
wherein said vision system is operable to determine a gaze direction of the authorized driver while the authorized driver is operating the vehicle.

14. The vision system of claim 13, comprising an exterior camera having a field of view exterior of the vehicle, wherein said image processor is operable to determine the presence of a person in the field of view of said exterior camera and to compare features of the person in the field of view of said exterior camera to features of an authorized driver, wherein, responsive at least in part to the comparison of features of the person in the field of view of said exterior camera, opening of a door of the vehicle is allowed only to an authorized driver.

15. The vision system of claim 13, wherein, responsive to a comparison of a location of the person's head when the person is occupying the driver seat of the vehicle to a location of the head of an authorized driver, operation of the vehicle is allowed only to an authorized driver.

16. The vision system of claim 13, wherein said vision system is operable to learn features of an authorized driver.

17. The vision system of claim 13, wherein said vision system is operable to adjust at least one accessory responsive to the gaze direction of the authorized driver.

18. The vision system of claim 13, wherein said vision system learns a driving characteristic of the authorized driver and adjusts at least one accessory of the vehicle responsive to the learned driving characteristic.

19. A vision system of a vehicle, said vision system comprising:
an interior camera disposed in an interior cabin of a vehicle and having a field of view interior of the vehicle that encompasses an area typically occupied by a head of a driver of the vehicle;
wherein said vision system is operable to store features of multiple authorized drivers;
an image processor operable to process image data captured by said interior camera;
wherein said image processor is operable to determine the presence of a person's head in the field of view of said interior camera and to compare features of the person's face to features of authorized drivers;
wherein, responsive at least in part to the comparison of features, operation of the vehicle is allowed only to one of the authorized drivers; and
wherein said vision system learns a driving characteristic of the authorized drivers and adjusts at least one accessory of the vehicle responsive to the learned driving characteristic of the authorized driver that is operating the vehicle.

20. The vision system of claim 19, wherein said vision system comprises a display operable to display traffic sign information indicative of a traffic sign ahead of the vehicle to enhance the authorized driver's awareness of the traffic sign, and wherein said vision system is operable to determine a gaze direction of the authorized driver while the authorized driver is operating the vehicle and is operable to determine when the authorized driver views the traffic sign, and wherein said vision system learns an attentiveness of the authorized driver when the authorized driver is operating the vehicle, and wherein said vision system adjusts the display of the traffic sign responsive to the authorized driver's attentiveness and the determined driver's gaze being towards the traffic sign.
